(19) United States
(12) Patent Application Publication
(10) Pub. No.: US 2026/0006164 A1
(43) Pub. Date: Jan. 1, 2026

(54) DATA ACQUISITION APPARATUS, VIRTUAL SPACE DISPLAY SYSTEM, DATA ACQUISITION METHOD, PROGRAM, AND RECORDING MEDIUM

(71) Applicant: FUJIFILM Corporation, Tokyo (JP)

(72) Inventors: YUYA NISHIO, Saitama-shi (JP); TOSHIKI KOBAYASHI, Saitama-shi (JP); MASARU KOBAYASHI, Saitama-shi (JP); KEI YAMAJI, Saitama-shi (JP)

(73) Assignee: FUJIFILM Corporation, Tokyo (JP)

(21) Appl. No.: 19/320,301

(22) Filed: Sep. 5, 2025

Related U.S. Application Data
(63) Continuation of application No. PCT/JP2024/006556, filed on Feb. 22, 2024.

(30) Foreign Application Priority Data
Mar. 16, 2023 (JP) 2023-041730

(51) Int. Cl. H04N 13/178; H04N 13/156; H04N 13/361

(52) U.S. Cl. CPC H04N 13/178; H04N 13/156; H04N 13/361

(57) ABSTRACT

Provided are an apparatus, a method, a program, and a recording medium that make it easier to adjust a physical quantity associated with object data in accordance with a space corresponding to the object data.

A data acquisition apparatus includes a processor configured to execute: first acquisition processing of acquiring first object data associated with a physical quantity that is converted into data and corresponding to a first space; and second acquisition processing of performing first conversion related to the physical quantity on the first object data based on a reference, to acquire second object data associated with the physical quantity after the first conversion and corresponding to a second space different from the first space.

### CROSS-REFERENCE TO RELATED APPLICATIONS

This application is a Continuation of PCT International Application No. PCT/JP2024/006556 filed on Feb. 22, 2024, which claims priority under 35 U.S.C. § 119(a) to Japanese Patent Application No. 2023-041730 filed on Mar. 16, 2023. The above applications are hereby expressly incorporated by reference, in their entirety, into the present application.

### BACKGROUND OF THE INVENTION

### 1. Field of the Invention

One embodiment of the present invention relates to a data acquisition apparatus that acquires object data associated with a physical quantity that is converted into data, a virtual space display system, a data acquisition method, a program, and a recording medium.

### 2. Description of the Related Art

In a virtual space such as a virtual reality (VR) space, an object indicating a person or an article may be disposed, and an image of a part of the space may be displayed. In order to dispose and display the object in the virtual space, it is necessary to define a display size thereof and acquire data (hereinafter, referred to as object data) associated with the display size.

For example, in the invention disclosed in WO2020/174586A, user body size data representing a body size of a user in a real space and character body size data representing a body size of a virtual character are acquired. Then, the character is displayed in the virtual space based on both the user body size data and the character body size data. Specifically, a scaling coefficient is calculated based on a ratio between the user body size data and the character body size data, and a position of each node of the character in the virtual space is determined based on the scaling coefficient.

### SUMMARY OF THE INVENTION

In the invention disclosed in WO2020/174586A, in a case of trying to reproduce the object having the same size as the real space in the virtual space, there is a concern that the object may not be able to appropriately correspond to a relationship with a size of another object. For example, in a case in which a person object and a building object are disposed in the virtual space, the respective sizes may be set to the same sizes as in the real space. In this case, the building object may be too large for the person object, and thus it may be difficult to display both objects on a screen, or it may be difficult to see the person with respect to the building.

Here, in a case in which a plurality of objects are disposed in the virtual space, it is conceivable to individually set the display size of each object in the virtual space so that each object can be appropriately displayed. Specifically, in a case in which an article or a person existing in a certain space (hereinafter, also referred to as a first space) is displayed as an object in a second space different from the first space, a size is set for each object.

In the above-described case, for example, in a case in which the first space is the real space and the second space is the virtual space, a size ratio between the objects in the first space is changed in the second space, so that a plurality of objects can be appropriately displayed. However, in a case in which the display size is set for each object, a lot of time and effort is required.

One embodiment of the present invention has been made to solve such problems in the related art, and an object of the present invention is to provide an apparatus, a method, a program, and a recording medium that make it easier to adjust a physical quantity associated with object data in accordance with a space corresponding to the object data.

The above-described object is achieved by a data acquisition apparatus according to any one of [1] to [15].
[1] A data acquisition apparatus comprising: a processor configured to execute: first acquisition processing of acquiring first object data associated with a physical quantity that is converted into data and corresponding to a first space; and second acquisition processing of performing first conversion related to the physical quantity on the first object data based on a reference, to acquire second object data associated with the physical quantity after the first conversion and corresponding to a second space different from the first space.
[2] The data acquisition apparatus according to [1], in which the physical quantity associated with the first object data is a physical quantity of an object, and in a case in which a target object corresponding to the object exists in the first space or it is assumed that the target object exists in the first space, the physical quantity of the object is determined in accordance with a physical quantity of the target object.
[3] The data acquisition apparatus according to [1] or [2], in which the processor is configured to, in the first acquisition processing, acquire the physical quantity associated with the first object data based on a measurement result of a physical quantity related to a target object existing in the first space or an input operation of a user related to the physical quantity.
[4] The data acquisition apparatus according to any one of [1] to [3], in which attribute data related to the first object data is associated with the first object data, and the processor is configured to, in the second acquisition processing, perform the first conversion on the first object data based on the reference corresponding to the attribute data.
[5] The data acquisition apparatus according to [4], in which, in a case in which a target object corresponding to an object based on the first object data exists in the first space or it is assumed that the target object exists in the first space, the attribute data is data related to the target object.
[6] The data acquisition apparatus according to [5], in which the attribute data is data related to a type of the target object.
[7] The data acquisition apparatus according to [4], in which the attribute data is data related to a physical quantity of an object based on the first object data.
[8] The data acquisition apparatus according to [4], in which the attribute data is data related to acquisition information or an acquisition condition of the first object data.
[9] The data acquisition apparatus according to any one of [1] to [8], in which a size of an object in the first space is associated with the first object data as the physical quantity, and a size of an object in the second space is associated with the second object data as the physical quantity.
[10] The data acquisition apparatus according to [9], in which, in the first conversion, the size of the object associated with the first object data is converted into the size of the object associated with the second object data in accordance with the reference that defines a relationship between sizes before and after conversion.
[11] The data acquisition apparatus according to [10], in which the reference defines the relationship in which the size after the conversion is larger as the size before the conversion is larger and a ratio of the size after the conversion to the size before the conversion is smaller as the size before the conversion is larger.
[12] The data acquisition apparatus according to any one of [1] to [11], in which the processor is configured to further execute storage processing of storing reverse conversion data for reverse-converting the second object data into the first object data in association with the second object data.
[13] The data acquisition apparatus according to any one of [1] to [12], in which the processor is configured to further execute third acquisition processing of performing second conversion related to the physical quantity on the second object data, to acquire third object data associated with the physical quantity after the second conversion and corresponding to a space different from the second space.
[14] The data acquisition apparatus according to [13], in which the third object data corresponds to a real space and is associated with a physical quantity of an object based on the third object data in the real space.
[15] The data acquisition apparatus according to [14], in which the third object data is data for displaying an image of the object in a superimposed manner on an image of the real space.

In addition, in order to solve the above-described problems, one embodiment of the present invention provides a virtual space display system comprising: the data acquisition apparatus according to any one of [1] to [15]; and an image display apparatus that displays an image of the second space in which an object based on the second object data acquired by the data acquisition apparatus is disposed.

In addition, in order to solve the above-described problems, one embodiment of the present invention provides a data acquisition method comprising: a step of acquiring, via a processor, first object data associated with a physical quantity that is converted into data and corresponding to a first space; and a step of performing, via the processor, first conversion related to the physical quantity on the first object data based on a reference, to acquire second object data associated with the physical quantity after the first conversion and corresponding to a second space different from the first space.

In addition, one embodiment of the present invention provides a program causing a computer to execute each step included in the data acquisition method described above.

In addition, one embodiment of the present invention provides a computer-readable recording medium on which a program causing a computer to execute each step included in the data acquisition method described above.

According to one embodiment of the present invention, there are provided the apparatus, the method, the program, and the recording medium that make it easier to adjust the physical quantity associated with the object data in accordance with the space corresponding to the object data.

### BRIEF DESCRIPTION OF THE DRAWINGS

FIG. 1 is a conceptual diagram of a virtual space display system according to one embodiment of the present invention.

FIG. 2 is a diagram showing a display example of an image of a virtual space.

FIG. 3 is a diagram showing an example of object data.

FIG. 4 is a diagram showing an example of a size of an object according to one embodiment of the present invention, and is a diagram showing a size in a real space and a size in the virtual space.

FIG. 5 is a diagram showing a procedure of converting the object data.

FIG. 6 is a diagram showing a hardware configuration of a data acquisition apparatus according to one embodiment of the present invention.

FIG. 7A is a diagram showing a first example of a reference used for the conversion of the object data.

FIG. 7B is a diagram showing a second example of the reference used for the conversion of the object data.

FIG. 7C is a diagram showing a third example of the reference used for the conversion of the object data.

FIG. 7D is a diagram showing a fourth example of the reference used for the conversion of the object data.

FIG. 8 is an explanatory diagram of functions of the data acquisition apparatus according to one embodiment of the present invention.

FIG. 9 is a diagram showing a display example of a screen based on third object data.

FIG. 10 is a diagram showing a data acquisition flow according to one embodiment of the present invention.

### DESCRIPTION OF THE PREFERRED EMBODIMENTS

Hereinafter, one specific embodiment of the present invention will be described. Hereinafter, for convenience, the description may be made in terms of a graphic user interface (GUI). Since basic data processing techniques (communication/transmission technique, data acquisition technique, data recording technique, data processing/analysis technique, image processing technique, visualization technique, and the like) for achieving the contents are known techniques, the description thereof will be omitted.

Further, the present specification, the concept of “apparatus” includes a single apparatus that exerts a specific function and includes a combination of a plurality of apparatuses that are present independently and that are distributed but operate together (cooperate) to exert a specific function.

In addition, in the present invention, the term “user” is a user of a data acquisition apparatus according to the embodiment of the present invention, and specifically, for example, a person who acquires object data described later by using functions of the data acquisition apparatus according to the embodiment of the present invention.

In addition, in the present specification, the term “space” may be a three-dimensional space or a two-dimensional space, but in the following description, the space is a three-dimensional space unless otherwise specified.

Further, in the present specification, the term “person” means a main person that performs specific behavior, can include an individual, a group, a corporation, such as a company, an organization, and the like, and can also further include a computer and a device that constitute artificial intelligence (AI). Artificial intelligence implements intellectual functions, such as reasoning, prediction, and decision, by using a hardware resource and a software resource. An artificial intelligence algorithm is optional, and, for example, an expert system, case-based reasoning (CBR), a Bayesian network, or an inclusion architecture may be used.

### Outline of Specific Embodiment of Present Invention

One embodiment of the present invention (hereinafter, referred to as the present embodiment) relates to a data acquisition apparatus, a virtual space display system, a data acquisition method, a program, and a recording medium.

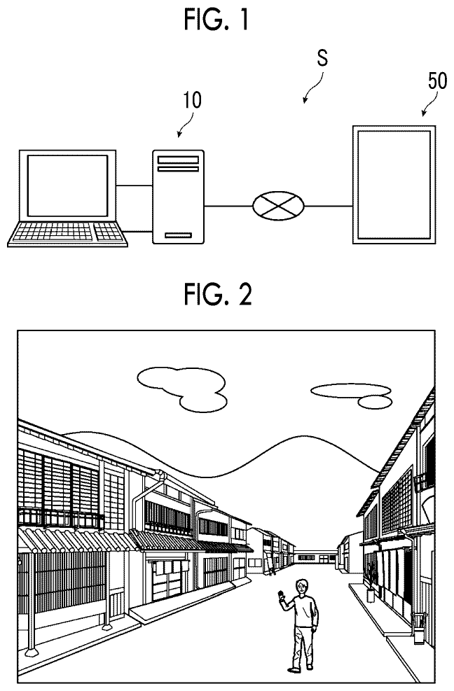

As shown in FIG. 1, a data acquisition apparatus (hereinafter, a data acquisition apparatus 10) according to the present embodiment constitutes a virtual space display system S together with an image display apparatus 50. The virtual space display system S displays an image of a virtual space on a predetermined screen by the image display apparatus 50 as an image based on data acquired by the data acquisition apparatus, as shown in FIG. 2. A user of the virtual space display system S can view the image of the virtual space displayed on the screen and appreciate or use the image.

The image may be a color image, a monochrome image, or a grayscale image. Further, the image may be a still image or a video image.

The virtual space is, for example, a space reproduced by a computer, and, specifically includes a virtual reality (VR) space, an augmented reality (AR) space, and a mixed reality (MR) space. Further, the virtual space may include a commercial virtual space such as a metaverse.

In addition, one or more objects exist in the virtual space. The object is an element that exists in the virtual space, and is a person, a character, an article, an organism, a vehicle, a plant, a building, a background, or the like that can be disposed in the virtual space. In addition, the object has a physical quantity in the virtual space, and, specifically, has a physical or exterior feature defined by the physical quantity in the virtual space.

The physical quantity need only be an index value representing a physical or exterior feature of the object, and may be, for example, a length, a size, a weight, hardness, softness, glossiness, or transparency. Further, the size in a case in which the object is a person or a humanoid character may include, for example, a ratio of a length of a head to a length of a body other than the head, that is, a human body ratio.

In a case of displaying the object by disposing the object in the virtual space, the object is reproduced in the virtual space, and object data is required for reproducing the object. The object data is data for object reproduction and is associated with the physical quantity that is converted into data. Here, the physical quantity associated with the object data is a physical quantity of the object based on the object data. That is, the object data is data for reproducing the object having the physical quantity defined by the data in the virtual space.

An aspect in which the object data is associated with the physical quantity may be an aspect in which the physical quantity that is converted into data is included in a file of the object data. That is, the data of the physical quantity may be incorporated into the object data as data of tag information. In addition, an aspect may be adopted in which a data file of the physical quantity that is converted into data is generated separately from the file of the object data, and a path to one data file or an identification ID (for example, a file name or the like) of the data file is stored in the other data file. Further, an aspect may be adopted in which a correspondence relationship between the file of the object data and the data file of the physical quantity that is converted into data is stored as another data file, for example, as table data.

In the virtual space display system S, the data acquisition apparatus 10 and the image display apparatus 50 are connected so as to be communicable with each other. The data acquisition apparatus 10 has a function of acquiring the object data. Here, an aspect in which the object data is acquired by the data acquisition apparatus 10 may include converting certain object data into another object data, newly generating object data, and the like. Further, searching for object data corresponding to a search condition from a database in which existing object data is accumulated can also be included in the aspect of acquiring the object data.

The image display apparatus 50 controls the display device based on the object data acquired by the data acquisition apparatus 10, and displays the image of the virtual space in which the object based on the object data is disposed on the screen of the display device. The image display apparatus 50 may be, for example, a terminal apparatus comprising a display as a display device, or may be an apparatus that displays an image on a display device that is a separate body from the image display apparatus 50. Further, the display device may be connected to the image display apparatus 50 in a wired or wireless format. It should be noted that the display device connected to the image display apparatus 50 can include a head mounted display (HMD), such as VR goggles, in addition to a general stationary display.

The user of the data acquisition apparatus 10 can view the image of the virtual space displayed based on the object data acquired by the data acquisition apparatus 10 through the image display apparatus 50. That is, the user of the data acquisition apparatus 10 is also the user of the image display apparatus 50 and the virtual space display system S. However, the present invention is not limited to this, and the user of the data acquisition apparatus 10 and the user of the image display apparatus 50 (that is, a viewer of the image of the virtual space) may be different from each other.

### <<Object Data>>

The object data is data for reproducing the object as described above. An object reproduced based on the object data (hereinafter, an object based on object data) is disposed in a space corresponding to the object data. Here, the space corresponding to the object data is mainly the virtual space, but it is also conceivable that the space corresponding to the object data is a real space.

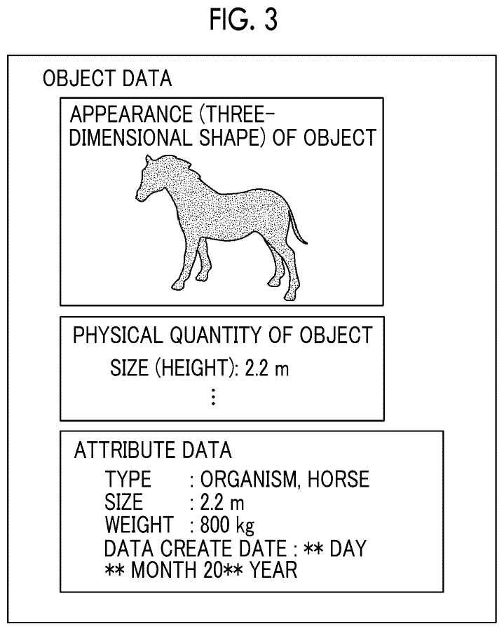

In addition, as shown in FIG. 3, the object data is data that defines an appearance of the object, specifically, a shape, a color, a pattern, a surface state, a skin sensation or texture, a posture, and the like. The data of the appearance of the object may be two-dimensional (2D) data or may be three-dimensional (3D) data. The 2D data is composed of a plurality of pixel data defined in a two-dimensional coordinate space, and each pixel data indicates, for example, a color and brightness of each single image in a case in which the object is divided into a plurality of pixels. The 3D data is composed of a plurality of voxel data in a three-dimensional coordinate space, and each voxel data indicates, for example, a color and a brightness of each voxel in a case in which the object is divided into a plurality of voxels.

In a case in which a target object corresponding to the object exists in the real space, the object data is acquired by scanning a three-dimensional shape of the target object (real object). Further, captured image data of the target object may be acquired as the object data by imaging the target object that actually exists in the real space with an imaging device such as a camera. The target object means a person, an organism other than a person, a building, an article, a landscape, an environment, and other objects that can be recognized in the real space. The fact that the target object exists in the real space can include a case in which the target object does not exist at the present time but has actually existed in the real space in the past.

On the other hand, in a case in which the target object corresponding to the object does not exist in the real space, the user assumes that the target object exists in the real space and draws the object corresponding to the target object by using image creation software or the like, to generate the object data. In this case, the user associates the size of one pixel on the screen for drawing with a predetermined length (for example, X millimeters or X centimeters: X is a real number) in the real space, and draws the object corresponding to the target object while assuming the size of the target object through the screen defined as having the predetermined length. As a result, the object is depicted as having the appearance and the size of the target object in a case in which it is assumed that the target object exists in the real space, and the object data associated with the size is acquired.

It should be noted that the present invention is not limited to the above-described case, and for example, the user may draw the object corresponding to the target object by directly inputting the dimensions of each part of the target object in a case of assuming that the target object exists in the real space. In this case, the object data associated with the size of the object input by the user is acquired.

In addition, as shown in FIG. 3, the object data is associated with the physical quantity that is converted into data, and the physical quantity includes, for example, the size of the object. The size of the object is a size of a region (range) occupied by the object in the virtual space. In other words, the object can be displayed in the virtual space in the size associated with the object data. In the following description, the size means a height (length in a vertical direction) of the object.

The size as the physical quantity associated with the object data is a size in the real space in a case in which the object data corresponds to the real space. More specifically, in a case in which the target object (real object) corresponding to the object exists in the real space, a real size of the target object may be converted into data and associated with the object data. On the other hand, in a case in which the target object corresponding to the object does not exist in the real space, the size associated with the object data may be a size in a case in which it is assumed that the target object exists in the real space. Stated another way, a size determined by assuming a fictitious person, organism, article, building, or the like may be associated with the object data.

In addition, in the present embodiment, the size of the object associated with the object data is determined in accordance with the space corresponding to the object data as the size in the space. That is, in the present embodiment, a plurality of object data may be generated for the same object, and, in this case, the size associated with each object data may be changed in accordance with the space corresponding to each object data.

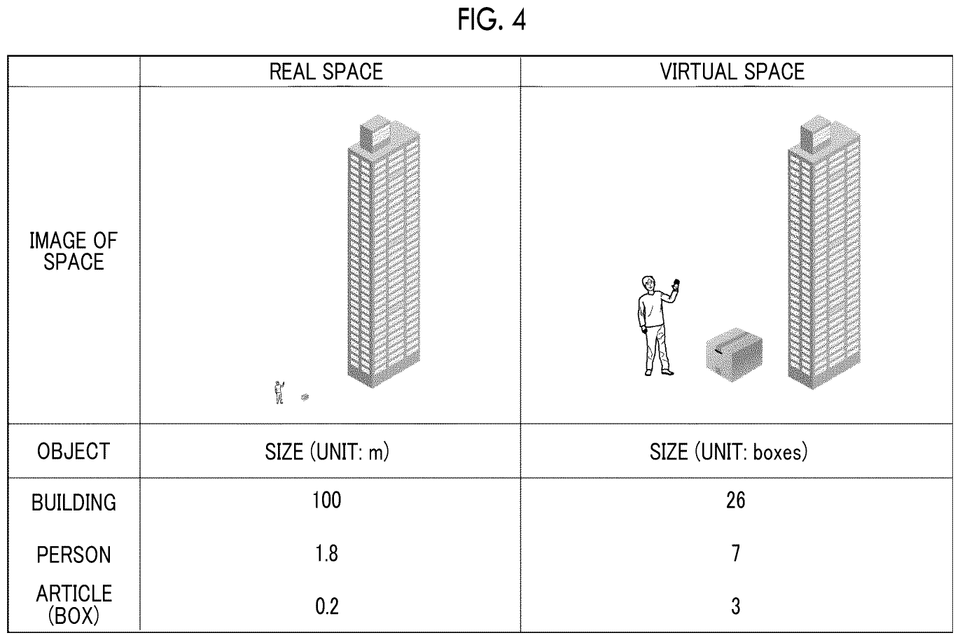

For example, as shown in FIG. 4, it is assumed that data corresponding to the virtual space and data corresponding to the real space are acquired as the object data of each object corresponding to each of a real building, person, or article. In this case, the sizes associated with the respective object data may be different from each other between the respective object data as shown in the same drawing.

A unit of the size associated with the object data may be set in accordance with the space corresponding to the object data, and may be different for each space as shown in FIG. 4. In FIG. 4, “m (meter)” is used as the unit of the size of the real space, and “boxes”, which is a unit independently determined by a designer of the virtual space, is used as the unit of the size of the virtual space.

In addition, as shown in FIG. 3, attribute data related to the object based on the object data may be associated with the object data. An aspect in which the attribute data is associated with the object data may be an aspect in which the attribute data is included in the file of the object data. That is, the attribute data may be incorporated into the object data as the data of the tag information. In addition, an aspect may be adopted in which a file of the attribute data is generated separately from the file of the object data, and a path to one data file or an identification ID (for example, a file name or the like) of the data file is stored in the other data file. Further, an aspect may be adopted in which a correspondence relationship between the file of the object data and the data file of the attribute data is stored as another data file, for example, as table data.

The attribute data is data related to an attribute of the object, and the attribute is the concept for classifying, specifying, identifying, or characterizing the object. Specifically, the attribute data may be data indicating a type of the object or a component (specification) of the object. In addition, in a case in which the target object corresponding to the object exists in the real space or it is assumed that the target object exists in the real space, the attribute data may be data related to the target object. In this case, the attribute data may be data related to the type of the target object.

In addition, the attribute data is data related to the physical quantity of the object, and specifically, may be data related to the size of the object or data related to the size of the target object corresponding to the object. The data related to the size may be data indicating the size directly, for example, data indicating a numerical value such as a dimension value, or may be data indicating a rank or the like determined in accordance with the size. Further, the data related to the size may be data indicating a range including the size of the object or the target object (for example, a range of a meter to b meters: a and b are real numbers).

Further, in a case in which the object data is obtained by imaging the target object corresponding to the object, the attribute data associated with the object data may be data related to the captured image of the target object. Specifically, data related to an imaging time (season), an imaging place, an imaging condition, and the like of the captured image may be included as the attribute data. Here, the imaging time, the season, the imaging place, and the like of the image data correspond to acquisition information of the object data, and the imaging condition of the image data corresponds to an acquisition condition of the object data.

The attribute data may be generated based on, for example, an input operation of the user in a case of acquiring the object data. Alternatively, artificial intelligence (AI) or the like may analyze the object data, and the attribute data may be generated based on the analysis result thereof.

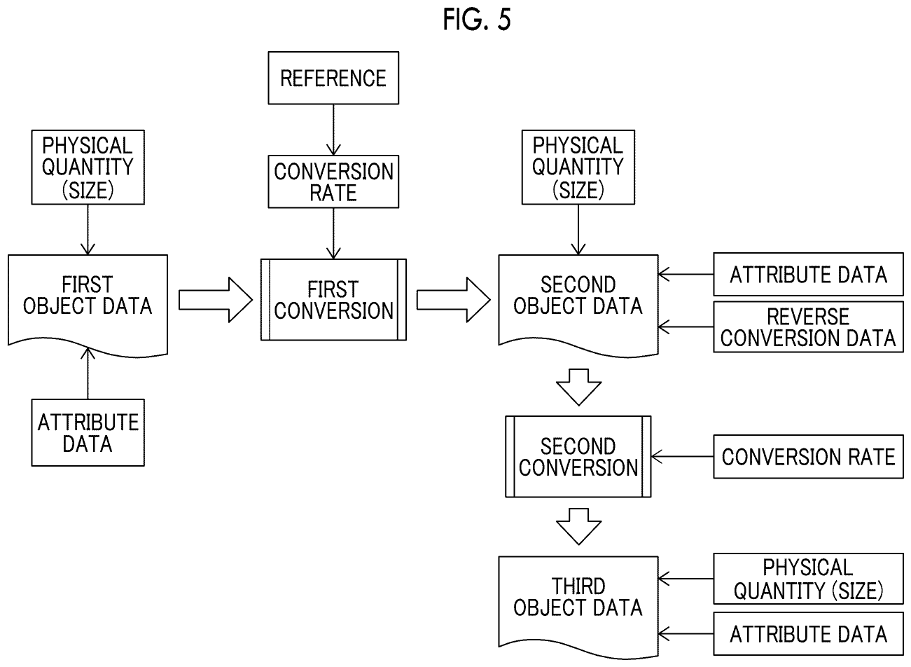

In addition, the object data may include data other than the above-described data, and for example, reverse conversion data described later may be associated (see FIG. 5). An aspect of associating the data with the object data is the same as an aspect of associating the attribute data with the object data.

### <<Change in Physical Quantity Accompanying Display of Object in Virtual Space>>

In a case of displaying the object in the virtual space, it is necessary to define the size of the object in the virtual space. For example, in a case in which the 3D data of the target object measured in the real space is used as the object data to display the object corresponding to the target object in the virtual space, the same size ratio as the real space is maintained between the objects.

As a specific example, in a case in which a person object and a building object are displayed in the virtual space and the same size ratio as the real space is used, the building object may be too large with respect to the person object, and it may be difficult to display the entire building on the display screen. Further, in the above-described case, in a case in which an object smaller than the person object, for example, an object such as an accessory is displayed, a display size of the object is extremely small, and there is a concern that it is difficult to visually recognize the object on the screen.

In addition, in a case in which an avatar (person object) in the virtual space is operated while being viewed on the screen and is moved in the virtual space and the size ratio between the objects is the same as the value in the real space, the size (expansion of the space) of the virtual space is excessively large. As a result, a problem occurs, such as an increase in time for moving the avatar in the virtual space.

Therefore, in the present embodiment, the size of the object in the virtual space is adjusted from the size of the real space to a size suitable for display in the virtual space. However, in a case in which an adjustment method is individually set for each of a plurality of objects existing in the virtual space and the size of each object is adjusted by the individual adjustment method, a large amount of work may be generated, and there is a concern that the processing load is excessively increased.

Therefore, in the present embodiment, the size of each object is adjusted in accordance with a predetermined reference in a case of adjusting the size. As a result, a burden of the size adjustment work and the load of data processing associated therewith are reduced, and the size (physical quantity) of each object can be efficiently adjusted.

In addition, in the present embodiment, in order to adjust the size of the object, the conversion related to the physical quantity is performed on first object data associated with the size of the object before the adjustment. As a result, as shown in FIG. 5, second object data associated with the size after the adjustment is acquired. The first object data is object data corresponding to a first space, and the second object data is object data corresponding to a second space. In the present embodiment, the first space corresponds to the real space, and the second space is a space different from the first space and corresponds to the virtual space.

The conversion performed on the first object data is conversion related to the size, which is the physical quantity of the object, and specifically, is data processing of changing the size of the object in accordance with the virtual space (second space). Hereinafter, this conversion will be referred to as first conversion. In the present embodiment, the first conversion is conversion for the first object data, in other words, conversion for the size which is the physical quantity associated with the first object data.

Here, the size conversion of the object may include changing the size of each part in one object while maintaining the size ratio between the parts, as well as changing the size ratio between the parts together with the size of each part, that is, deformation.

Further, in the present embodiment, as shown in FIG. 5, the conversion for the size adjustment is performed again on the second object data, so that third object data associated with the readjusted size can be acquired. The third object data is object data corresponding to a third space, and the third space is a space different from the second space.

The conversion performed on the second object data is conversion related to the size, which is the physical quantity of the object, and specifically, is data processing of changing the size of the object in accordance with the third space. Hereinafter, this conversion will be referred to as second conversion. The second conversion is conversion for the second object data, in other words, conversion for the size associated with the second object data.

Here, the third space may be the virtual space different from the second space or may be the real space (that is, the same space as the first space). In addition, the size of the object associated with the third object data may be the size before the first conversion is performed (size before the conversion).

That is, in the present embodiment, the size of a certain object can be restored to the size in the real space by converting the size of the object from the size of the target object corresponding to the object (that is, the size in the real space) to the size in the virtual space and then reconverting the size. As a result, it is possible to display the object in the virtual space by making the object larger (or smaller) than the size in the real space, and to display the object in the size in the real space. As a case in which the object is displayed in the size in the real space, for example, a scene in which the object is displayed in a real size in an AR space is shown (see FIG. 9).

### <<Configuration Example of Data Acquisition Apparatus According to Present Embodiment>>

The data acquisition apparatus 10 is used by the user for acquiring the object data. As described above, the user who has acquired the object data can visually recognize the image of the virtual space in which the object based on the object data is disposed by the functions of the image display apparatus 50.

The data acquisition apparatus 10 may be an apparatus owned by the user or may be an apparatus installed in a store or the like. The apparatus set in the store or the like corresponds to a terminal, a computer, or the like that can be used by the user inputting a password, a PIN, or the like or making a payment in a case of visiting the store or the like, even though the user does not own the apparatus.

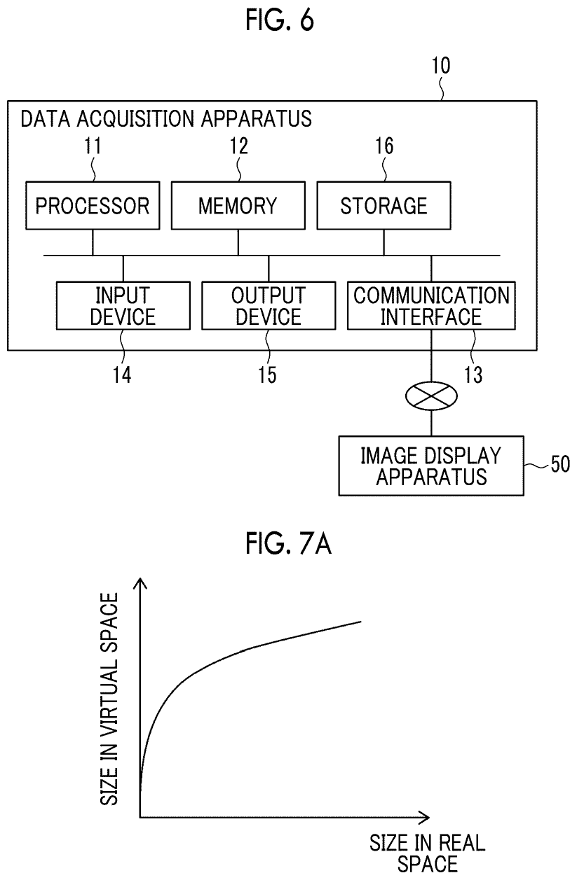

As shown in FIG. 6, the data acquisition apparatus 10 comprises a processor 11, a memory 12, and a communication interface 13. The processor 11 is composed of, for example, a central processing unit (CPU), a graphics processing unit (GPU), a digital signal processor (DSP), or a tensor processing unit (TPU). The memory 12 is composed of, for example, semiconductor memories such as a read-only memory (ROM) and a random-access memory (RAM). The communication interface 13 is composed of, for example, a network interface card or a communication interface board.

A program (hereinafter, a data acquisition program) causing the processor 11 to acquire the object data is stored in the memory 12. The data acquisition program is a program causing the processor 11 to execute each step in a data acquisition flow described later. The data acquisition program may be acquired by being read from a computer-readable recording medium or may be acquired by being downloaded through a communication network such as the Internet or an intranet.

The data acquisition apparatus 10 can communicate with another apparatus through the communication interface 13 and transmit and receive data to and from the apparatus. The data acquisition apparatus 10 can communicate with, for example, an apparatus (3D scanner) that scans a three-dimensional shape of the target object and a measuring instrument that measures an appearance of the target object. Through the communication with these apparatuses, the data acquisition apparatus 10 can acquire the measurement results of the appearance and the physical quantity (size) of the target object. Then, the data acquisition apparatus 10 acquires data of the object corresponding to the target object based on the acquired measurement result.

The above-described 3D scanner and measuring instrument may constitute the data acquisition apparatus according to the embodiment of the present invention or may have a part of the function of the data acquisition apparatus according to the embodiment of the present invention.

The data acquisition apparatus 10 further comprises an input device 14 and an output device 15 as shown in FIG. 6. The input device 14 is composed of a touch panel, a cursor button, and the like, and receives the input operation of the user. The input operation of the user includes an operation of the user drawing the object using image creation software or the like, and an operation of inputting the physical quantity such as a size of the target object. In a case in which such an input operation is received by the input device 14, the data acquisition apparatus 10 acquires the object data based on the input operation of the user. Specifically, the object data indicating the appearance of the object drawn by the user and the physical quantity (size) input by the user are acquired by the data acquisition apparatus 10.

Further, the output device 15 includes a display device such as a display, a printing device such as a printer, and the like. The display device may display the image of the virtual space in which the object based on the object data acquired by the data acquisition apparatus 10 is disposed. Stated another way, the data acquisition apparatus 10 may have a function as the image display apparatus 50, and the data acquisition apparatus 10 and the image display apparatus 50 may be configured by the same computer.

Further, the data acquisition apparatus 10 can freely access various types of information stored in the storage 16. The information stored in the storage 16 may include a reference (reference will be described later) related to the size conversion, other information used for the object data acquisition, and the like. The acquired object data may be stored in the storage 16.

It should be noted that the storage 16 may be built in or externally attached to the data acquisition apparatus 10, or may be configured by a network-attached storage (NAS) or the like. Alternatively, the storage 16 may be an external device that can communicate with the data acquisition apparatus 10 through the Internet, a mobile communication network, or the like, for example, an online storage.

The data acquisition apparatus 10 is directly or indirectly operated by the user in a case of acquiring the object data. For example, in a case in which the data acquisition apparatus 10 is configured by the user terminal, the user can obtain desired object data by directly operating the data acquisition apparatus 10. Examples of the user terminal constituting the data acquisition apparatus 10 include a personal computer (PC), a smartphone, a tablet terminal, and a digital camera having a data processing function.

The data acquisition apparatus 10 may be configured by a server computer for an application service provider (ASP), software as a service (SaaS), a platform as a service (PaaS), or an infrastructure as a service (IaaS). In this case, in a case in which the user inputs necessary information through a client terminal, the server computer executes a series of processing related to the acquisition of the object data based on the input information. That is, in the above-described case, the user can indirectly operate the data acquisition apparatus 10 via the client terminal to obtain desired object data.

### <<Reference Used for Conversion of Object Data>>

In the present embodiment, the second object data can be acquired by performing the first conversion on the first object data based on a predetermined reference. Then, the size of the object associated with the second object data is converted from the size associated with the first object data and is adjusted in accordance with a space (virtual space) corresponding to the second object data.

The above-described reference used for the first conversion is set in advance and is stored in the storage 16 of the data acquisition apparatus 10. Here, the fact that the reference is set in advance means that the reference is set at a point in time before the first conversion is performed, and for example, the reference may be set immediately before the first conversion is performed.

In the present embodiment, the reference is a definition of a relationship between the sizes before and after the conversion, and specifically, a conversion expression, a conversion matrix, a conversion function, or a conversion rule such as “in a case in which the real dimension is in a range of a meter to Y meters, multiply a times: a, Y, and a are real numbers”. In addition, the reference is set in accordance with the attribute data associated with the first object data, and specifically, is set in accordance with the attribute data related to the target object corresponding to the object based on the first object data.

More specifically, the reference is prepared for each type of the target object, and the reference for each type of the target object is stored in the storage 16. For example, a reference in a case in which the target object is a person, a reference in a case in which the target object is an article, and a reference in a case in which the target object is a building are stored in the storage 16, respectively. In addition, the reference in a case in which the target object is an article is stored in the storage 16 for each type of object. Then, a conversion amount in a case of converting the size in the real space into the size in the virtual space by the first conversion, specifically, a size ratio before and after the conversion changes in accordance with the type of the target object corresponding to the object to be subjected to the size conversion.

As a specific example, a case will be assumed in which the size in the real space of each of a building, a person, and a small article (box) existing in the real space is converted into the size in the virtual space by performing the first conversion. In this case, as shown in FIG. 4, the size ratios (conversion rates) before and after conversion may be different between the building, the person, and the small article.

The unit of the size after the conversion may be a unit applied in the virtual space, and in FIG. 4, the unit of the size before the conversion is “m (meter)”, while the unit of the size after the conversion is “boxes” which is a unit unique to the virtual space. In this case, the above-described reference may be a conversion reference for converting the unit of the size in the real space into the unit of the size in the virtual space.

By changing the size ratio before and after the conversion in accordance with the type of the target object as described above, it is possible to display each type of object in the virtual space in accordance with the intention of the designer of the virtual space. In addition, in the virtual space, the object (for example, the accessory) to be emphasized can be made to appear larger, and an object that does not need to be paid attention can be made to appear smaller.

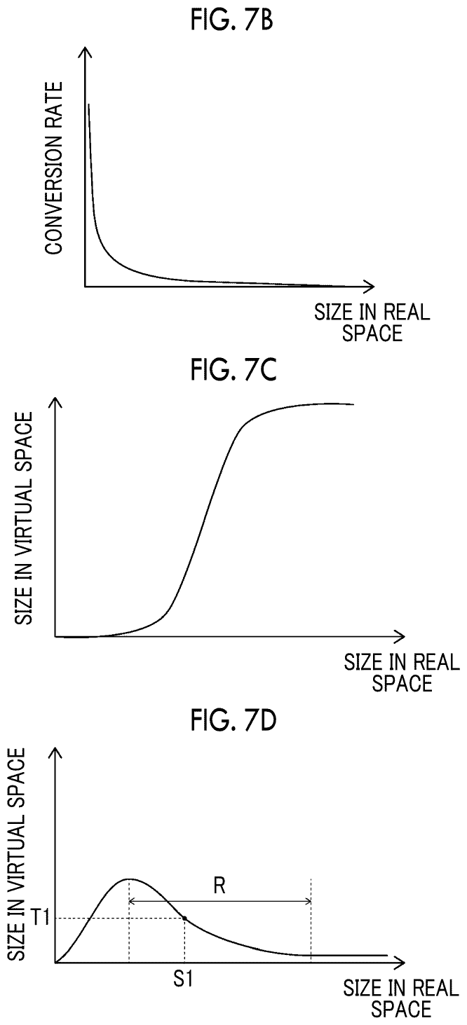

In addition, the reference may be defined as a relationship represented by the curves shown in FIGS. 7A to 7C as a relationship between the sizes before and after the conversion, and may change in accordance with the size before the conversion. As shown in FIG. 7A as an example, the reference may define a relationship in which the size after the conversion is larger as the size before the conversion is larger and the conversion rate (specifically, the reduction rate) is smaller as the size before the conversion is larger. Here, the reduction rate is a ratio of the size after the conversion to the size before the conversion.

By using the above-described reference, it is possible to convert the size of each object at the conversion rate (reduction rate) corresponding to the size of each object before the conversion while maintaining the size relationship between the objects before and after the conversion.

Contrary to the above-described reference, a reference that defines a relationship in which the size before the conversion is larger as the size after the conversion is larger and the conversion rate is smaller as the size before the conversion is larger may be used.

In addition, a reference shown in FIG. 7B, that is, a reference that defines a relationship in which the conversion rate (reduction rate) is smaller as the size before the conversion is larger, may be used. In addition, a reference shown in FIG. 7C, that is, a reference that defines a relationship in which the size after the conversion is larger as the size before the conversion is larger, and the sign of the ratio of the change amount of the reduction rate to the change amount of the size before the conversion is switched at the inflection point, may be used.

By using the above-described reference, it is possible to set an appropriate conversion rate in accordance with the size of the object that is a conversion target, such as increasing or decreasing the conversion rate for the object that is the conversion target.

### <<Function of Data Acquisition Apparatus According to Present Embodiment>>

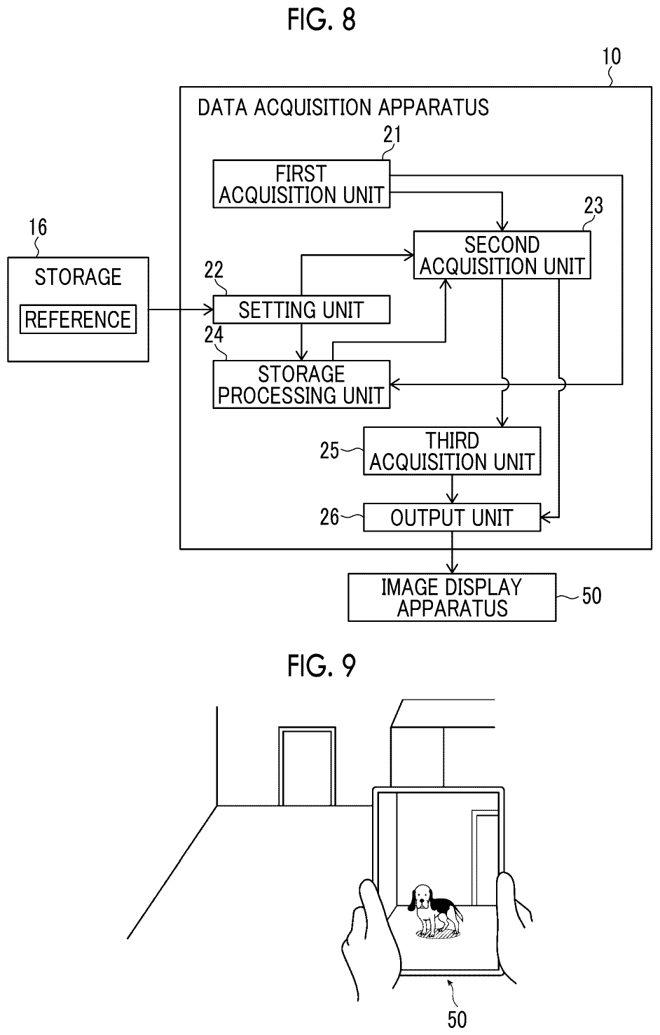

The configuration of the data acquisition apparatus 10 will be described again in terms of a functional aspect with reference to FIG. 8. As shown in FIG. 8, the data acquisition apparatus 10 includes a first acquisition unit 21, a setting unit 22, a second acquisition unit 23, a storage processing unit 24, a third acquisition unit 25, and an output unit 26. These functional units are implemented by cooperation between a hardware device of the data acquisition apparatus 10 and software including the data acquisition program. Further, some functions may be implemented by using artificial intelligence (AI). Hereinafter, each functional unit will be described.

### (First Acquisition Unit)

The first acquisition unit 21 acquires the first object data corresponding to the real space. A method of acquiring the first object data is not particularly limited, and for example, the first object data may be acquired by imaging the target object and acquiring data of the captured image as the first object data. In addition, 3D scanning may be performed on the three-dimensional shape of the target object to acquire scan data (3D data) as the first object data. In addition, in a case in which the user draws the object corresponding to the target object using image creation software or the like, drawing data may be acquired as the first object data.

As described above, the first object data is associated with the physical quantity converted into data, and the physical quantity is a physical quantity of the object based on the first object data, specifically, the size in the real space. Stated another way, the size of the object in the real space is associated with the first object data as the physical quantity. The size (physical quantity) of the object in the real space is determined in accordance with the size (physical quantity) of the target object in a case in which the target object corresponding to the object exists in the real space or it is assumed that the target object exists in the real space.

Specifically, in a case of acquiring the first object data, the first acquisition unit 21 receives the measurement result of the size of the target object existing in the real space or the input operation of the user related to the size of the target object. The measurement result of the size is, for example, an actual measurement value of the dimensions of each part of the target object, a dimension value obtained by analyzing the scan data obtained by performing the 3D scanning on the target object, or the like. The input operation of the user is an operation in which the user inputs the size of the target object under the assumption that the target object exists in the real space, an operation in which the user inputs the size of the target object existing in the real space, or the like.

The first acquisition unit 21 acquires the size (physical quantity) of the object associated with the first object data based on the received measurement result or input operation.

Further, the first acquisition unit 21 associates the attribute data related to the first object data with the first object data. The attribute data may be data related to the target object, in particular, data related to the type of the target object in a case in which the target object corresponding to the object based on the first object data exists in the real space or it is assumed that the target object exists in the real space. In addition, the attribute data may be data related to the size of the target object or data related to the size of the object based on the first object data. In addition, in a case in which the first object data is data of the captured image of the target object, data related to the acquisition information or the acquisition condition of the first object data may be associated with the first object data as the attribute data.

As described above, the attribute data is generated based on the input information of the user or the information on the analysis result in a case in which artificial intelligence (AI) analyzes the first object data.

### (Setting Unit)

The setting unit 22 sets the conversion amount in the first conversion, strictly speaking, the size ratio before and after the conversion, in accordance with the first object data that is the conversion target. Specifically, the setting unit 22 selects a reference to be applied in a case of performing the first conversion, in accordance with the attribute data associated with the first object data that is the conversion target. More specifically, a reference corresponding to the type of the target object indicated by the attribute data is selected from among a plurality of references stored in the storage 16.

After the selection of the reference, the setting unit 22 sets the conversion amount based on the selected reference and the size of the object associated with the first object data. Specifically, the conversion amount corresponding to the size is set by applying the size of the object to the above-described reference. For example, in a case in which the conversion amount is set using the reference shown in FIGS. 7A to 7C, a size corresponding to the size before the conversion is specified as the size after the conversion from the reference, a conversion rate (for example, a reduction rate) is obtained from the size after the conversion and the size before the conversion, and the conversion amount is set in accordance with the conversion rate.

In a case in which the attribute data related to the size of the target object is associated with the first object data, the size of the target object may be regarded as the size of the object, and the conversion amount may be set from the size of the target object indicated by the attribute data.

By the above-described procedure, in the present embodiment, the conversion amount in the first conversion is automatically set in accordance with the first object data that is the conversion target, specifically, the type, size, and the like of the target object corresponding to the object based on the first object data. As a result, for various objects, in a case in which the conversion of the first object data is performed, the processing load required for setting the conversion amount is reduced as compared with a case in which the conversion amount unique to each object is set for each object.

### (Second Acquisition Unit)

The second acquisition unit 23 performs the first conversion on the first object data based on the above-described reference to acquire the second object data associated with the size (physical quantity) after the first conversion. In the first conversion, the size of the object associated with the first object data is converted into the size of the object associated with the second object data in accordance with the above-described reference that defines the relationship between the sizes before and after the conversion.

Specifically, in the first conversion, the second acquisition unit 23 converts the size of the object associated with the first object data, that is, the size before the conversion, in accordance with the conversion amount set by the setting unit 22. Then, the size of the object is adjusted to the size of the object associated with the second object data, by the first conversion. Here, the size after the conversion associated with the second object data is the size of the object in the virtual space.

### (Storage Processing Unit)

The storage processing unit 24 executes storage processing of storing the reverse conversion data in association with the second object data. The reverse conversion data is data for reverse-converting the second object data, which is converted from the first object data by performing the first conversion, into the first object data. The reverse conversion data may be, for example, data related to a size associated with the first object data, that is, data related to a size of the object based on the first object data. Alternatively, data indicating a conversion amount during the first conversion, that is, a size ratio before and after the conversion set by the setting unit 22 may be used as the reverse conversion data.

Since the reverse conversion data is associated with the second object data as described above, for example, the size after the first conversion can be restored to the size before the conversion. In other words, the object based on the first object data can be restored by performing the reverse conversion on the second object data based on the reverse conversion data.

It should be noted that an aspect of associating the reverse conversion data with the second object data is the same as an aspect of associating the attribute data with the object data.

### (Third Acquisition Unit)

The third acquisition unit 25 performs the second conversion on the second object data to acquire the third object data. The third object data corresponds to a space different from the second space, and corresponds to the size (physical quantity) after the second conversion. In the present embodiment, the third object data corresponds to the real space, and is associated with the size of the object in the real space based on the third object data.

That is, the size associated with the third object data is the same as the size associated with the first object data. In other words, the second conversion is reverse conversion from the second object data to the first object data, and can be performed, for example, by using the above-described reverse conversion data.

The space corresponding to the third object data is not limited to the real space, and may be, for example, a virtual space different from the virtual space corresponding to the second object data. That is, the third acquisition unit 25 may acquire the third object data corresponding to the virtual space as the third space, and the size converted by performing the second conversion is associated with the data. In this case, the reference applied in a case in which the second conversion is performed may be set in advance and stored in the storage 16. In addition, the reference may be set in accordance with the type of the target object corresponding to the object based on the second object data and stored for each type of the target object, similarly to the reference applied in a case in which the first conversion is performed.

### (Output Unit)

The output unit 26 outputs the second object data acquired by the second acquisition unit 23 and the third object data acquired by the third acquisition unit 25, to a predetermined output destination. For example, the output unit 26 outputs the second object data to the image display apparatus 50. The image display apparatus 50 receives the second object data to dispose the object based on the second object data in the virtual space and display, for example, the image of the object in the virtual space. In such a case, the object is displayed in a size associated with the second object data.

In addition, the output unit 26 outputs the third object data to the image display apparatus 50, in particular, an apparatus having a function of displaying the AR space. In this case, the third object data is data for displaying the image of the object based on the third object data in a superimposed manner on the image of the real space.

That is, the image display apparatus 50 that has received the third object data images the real space by a camera or the like provided in the image display apparatus 50, and displays the captured image, strictly speaking, a live view image, on the screen. Then, the image display apparatus 50 displays the image of the object based on the third object data in a superimposed manner on the live view image. In such a case, the object is displayed in a size associated with the third object data. This size may be a size of the target object in a case in which the target object corresponding to the object exists in the real space or it is assumed that the target object exists in the real space. As a result, the object can be displayed in an appropriate size in the real space in which the object is virtually disposed, that is, the AR space.

In displaying or using the image of the AR space in which the object is disposed, it is preferable to execute projective conversion of deforming the shape of the object in accordance with a display or use range in the space, a direction (azimuth) of the range, and the like.

### <<Operation Example of Data Acquisition Apparatus According to One Embodiment of Present Invention>>

Next, as an operation example of the data acquisition apparatus 10 in the present embodiment, the data acquisition flow using the data acquisition apparatus 10 will be described. In the data acquisition flow described later, the data acquisition method according to the embodiment of the present invention is used. That is, each step in the data acquisition flow described later corresponds to a component of the data acquisition method according to the embodiment of the present invention.

The following flow is merely an example, and a part of steps in the flow may be deleted, a new step may be added to the flow, or an execution order of two steps in the flow may be exchanged without departing from the gist of the present embodiment.

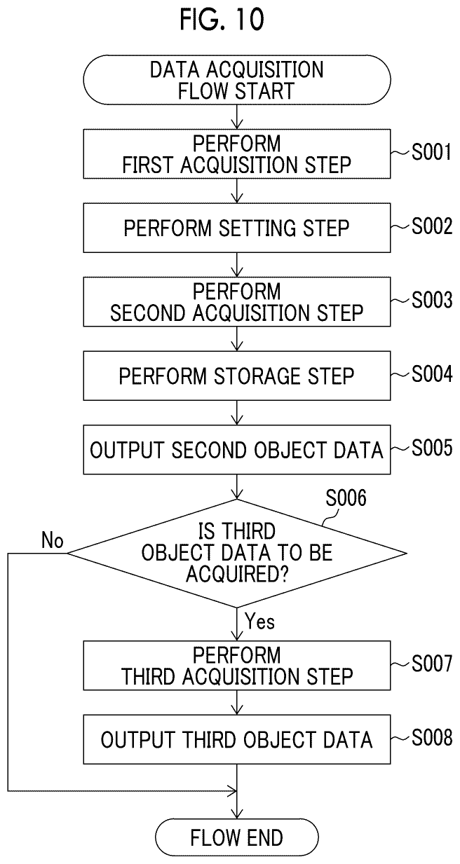

Each step in the data acquisition flow according to the present embodiment is performed by the processor 11 provided in the data acquisition apparatus 10 in the order shown in FIG. 10. In addition, in each step in the data acquisition flow, the processor 11 executes processing corresponding to each step in the data processing defined in the data acquisition program. Specifically, the processor 11 executes first acquisition processing in a first acquisition step, executes second acquisition processing in a second acquisition step, executes storage processing in a storage step, and executes third acquisition processing in a third acquisition step.

In the data acquisition flow according to the present embodiment, first, the first acquisition step of acquiring the first object data is performed (S001). In the first acquisition step, first object data corresponding to the real space is acquired, and specifically, the first object data is acquired by imaging the target object existing in the real space or performing the 3D scanning on the three-dimensional shape of the target object. In addition, in a case in which the target object does not exist in the real space, the user draws the object corresponding to the target object by assuming that the target object exists in the real space and using image creation software or the like. In this case, the drawing data of the object is acquired as the first object data.

In addition, in the first acquisition step, the size (physical quantity) of the target object is acquired based on the measurement result of the size of the target object or the input operation of the user related to the size of the target object, and the acquired size is associated with the first object data. Further, in the first acquisition step, the attribute data related to the first object data is associated with the first object data. The attribute data is data related to the target object corresponding to the object based on the first object data, and specifically, is data related to the type or the size of the target object. Further, the attribute data may be data related to the size of the object. In addition, the attribute data may be data related to the acquisition information or the acquisition condition of the first object data.

Next, the setting step of setting the conversion amount in the first conversion performed on the first object data, specifically, the size ratio before and after the conversion is performed (S002). In the setting step, the conversion amount is set in accordance with the attribute data associated with the first object data that is the conversion target. More specifically, the reference corresponding to the type of the target object indicated by the attribute data is selected from among the plurality of references stored in the storage 16. Then, the conversion amount is set based on the selected reference and the size associated with the first object data.

Next, the second acquisition step of acquiring the second object data by performing the first conversion on the first object data is performed (S003). In the first conversion, the size of the object associated with the first object data is converted into the size of the object associated with the second object data based on the above-described reference, and specifically, the size is changed in accordance with the conversion amount set in the above-described setting step. As a result, the second object data of which the size after the first conversion is associated is acquired.

Next, a storage step of creating reverse conversion data and storing the created reverse conversion data in association with the second object data is performed (S004). The reverse conversion data may be data related to the size associated with the first object data or may be data related to the conversion amount set in the setting step.

After the steps described above, the second object data is output to the predetermined output destination (S005). The second object data is displayed or used by the apparatus that has received the data. For example, in a case in which the image display apparatus 50 receives the second object data, the image of the virtual space in which the object based on the second object data is disposed is displayed on the screen of the display device.

In addition to the second object data, in a case in which the user requests the acquisition of the third object data, for example, data for disposing and displaying the object in the AR space (S006), the third acquisition step is performed (S007). In the third acquisition step, the second conversion is performed on the second object data to acquire the third object data corresponding to a space different from the second space. Further, the size after the second conversion is associated with the third object data.

After the third object data is acquired, the third object data is output to the predetermined output destination, and for example, is output to the image display apparatus 50 having a function of displaying the AR space (S008). The image display apparatus 50 displays the object based on the third object data in a superimposed manner on the image (strictly speaking, the live view image) of the real space. That is, the object is disposed in the AR space, and is displayed on the screen together with the image of the real space. In such a case, the object is displayed in the size associated with the third object data, specifically, in the size of the target object corresponding to the object.

The data acquisition flow ends at the point in time at which the series of steps described above are completed. As described above, in the data acquisition flow according to the present embodiment, the size of the object associated with the first object data is converted in accordance with the virtual space corresponding to the second object data to acquire the second object data. The conversion amount in this case is automatically set based on the attribute data associated with the first object data, specifically, the type, the size, and the like of the target object corresponding to the object based on the first object data. As a result, it is easy to set the conversion amount in accordance with the type and the size of the object, and thus the processing load on the conversion amount setting is reduced.

In addition, the object disposed in the virtual space is displayed with a size adjusted (converted) based on the preset reference. Specifically, the size of each object in the virtual space is adjusted in accordance with the intention of the designer of the virtual space, the degree of attention to each object, or the like. As a result, for example, for the object to be displayed in an emphasized manner in the virtual space, the conversion rate (strictly speaking, the magnification rate) can be set to be higher than the conversion rate for other objects, and the object can be displayed larger in the image of the virtual space.

### Other Embodiments

Although the specific embodiment of the present invention has been described above, the above-described embodiment is merely an example for ease of understanding of the present invention, and is not intended to limit the present invention. Stated another way, the present invention may be changed or improved from the embodiment described later without departing from the gist of the present invention. The present invention also includes an equivalent thereof. Furthermore, the embodiment of the present invention can include a form in which the above-described embodiment and one or more of the following modification examples are combined.

### (Modification Example Related to First Space and Second Space)

In the above-described embodiment, the real space corresponds to the “first space” according to the embodiment of the present invention, and the virtual space corresponds to the “second space” according to the embodiment of. However, the present invention is not limited to this, the virtual space may be the first space, and the real space may be the second space. In addition, the first space and the second space need only be spaces different from each other, one virtual space may be the first space, and another virtual space may be the second space.

### (Modification Example Related to Use of Object Data)

In the above-described embodiment, as an example of the use of the object data, a case has been described in which the image of the virtual space in which the object based on the object data is disposed is displayed. However, the use example of the object data is not limited to the above-described contents, and for example, the object data may be used for three-dimensional modeling by a 3D printer, specifically, constructing the three-dimensional shape of the object based on the object data.

### (Modification Example Related to Setting of Conversion Amount Based on Attribute Data)

In the above-described embodiment, the conversion amount in a case of converting the first object data is set in accordance with the attribute data associated with the first object data, and specifically, is set in accordance with the type, the size, and the like of the target object indicated by the attribute data. However, the present invention is not limited to this, and, in a case in which the attribute data related to the acquisition information or the acquisition condition of the first object data is associated with the first object data, the conversion amount may be set in consideration of the acquisition information or the acquisition condition.

As a specific example, it is assumed that the physical quantity adjusted by the conversion of the object data is a physical quantity that changes in conjunction with the brightness or chroma saturation of the object. In addition, it is assumed that the image data captured under a specific season, place, or imaging condition is acquired as the first object data, and the attribute data related to the season, place, or imaging condition is associated with the first object data. In this case, the conversion amount in a case of converting the first object data, more specifically, a reference to be applied in a case of setting the conversion amount may be determined in accordance with the season, the place, or the imaging condition indicated by the attribute data.

### (Modification Example of Reference Used for First Conversion)

In the above-described embodiment, the reference that defines the relationships shown in FIGS. 7A to 7C is used as the reference used for the first conversion, but the above-described reference is an example, and other references may be used. For example, as shown in FIG. 7D, in a case in which the size before the conversion is in a predetermined range (range R in FIG. 7D), a reference that defines a relationship in which the size after the conversion is smaller as the size is larger may be used. In a case of using this reference, for example, in a case in which the size before the conversion is Si, the first conversion is performed such that the size after the conversion is T1 in FIG. 7D.

### (Modification Example of Physical Quantity to be Converted)

In the above-described embodiment, the size associated with the object data is adjusted (converted) by converting the object data. However, the physical quantity adjusted by the conversion of the object data may be a physical quantity other than the size, and may be, for example, a weight, hardness, softness, glossiness, or transparency.

### (Configuration of Processor)

The processor provided in the data acquisition apparatus according to the embodiment of the present invention includes various processors. Examples of the various processors include a CPU, which is a general-purpose processor that executes software (program) to function as various processing units.

Furthermore, the various processors include a programmable logic device (PLD), which is a processor of which a circuit configuration is changeable after manufacture, such as a field-programmable gate array (FPGA).

Furthermore, the various processors described above also include a dedicated electric circuit, which is a processor of which a circuit configuration is specially designed for executing specific processing, such as an application-specific integrated circuit (ASIC).

In addition, one functional unit included in the data acquisition apparatus according to the embodiment of the present invention may be composed of one of the various processors described above. Alternatively, one functional unit included in the data acquisition apparatus according to the embodiment of the present invention may be configured by a combination of two or more processors of the same type or different types, for example, a combination of a plurality of FPGAs or a combination of an FPGA and a CPU.

In addition, the plurality of functional units included in the data acquisition apparatus according to the embodiment of the present invention may be composed of one of various processors, or two or more of the plurality of functional units may be collectively composed of one processor.

Further, as in the above-described embodiment, a form may be adopted in which one processor is composed of a combination of one or more CPUs and software, and the processor functions as the plurality of functional units.

In addition, for example, as typified by a system-on-chip (SoC) or the like, a form may be adopted in which a processor is used which implements the functions of the entire system including the plurality of functional units in the data acquisition apparatus according to the embodiment of the present invention with one integrated circuit (IC) chip. Moreover, a hardware configuration of the various processors may be an electric circuit (circuitry) in which circuit elements such as semiconductor elements are combined.

### EXPLANATION OF REFERENCES

10: data acquisition apparatus
11: processor
12: memory
13: communication interface
14: input device
15: output device
16: storage
21: first acquisition unit
22: setting unit
23: second acquisition unit
24: storage processing unit
25: third acquisition unit
26: output unit
50: image display apparatus
S: virtual space display system

What is claimed is:

1. A data acquisition apparatus comprising:
a processor configured to execute:
first acquisition processing of acquiring first object data associated with a physical quantity that is converted into data and corresponding to a first space; and
second acquisition processing of performing first conversion related to the physical quantity on the first object data based on a reference, to acquire second object data associated with the physical quantity after the first conversion and corresponding to a second space different from the first space.

2. The data acquisition apparatus according to claim 1,
wherein the physical quantity associated with the first object data is a physical quantity of an object, and
in a case in which a target object corresponding to the object exists in the first space or it is assumed that the target object exists in the first space, the physical quantity of the object is determined in accordance with a physical quantity of the target object.

3. The data acquisition apparatus according to claim 1,
wherein the processor is configured to, in the first acquisition processing, acquire the physical quantity associated with the first object data based on a measurement result of a physical quantity related to a target object existing in the first space or an input operation of a user related to the physical quantity.

4. The data acquisition apparatus according to claim 1,
wherein attribute data related to the first object data is associated with the first object data, and
the processor is configured to, in the second acquisition processing, perform the first conversion on the first object data based on the reference corresponding to the attribute data.

5. The data acquisition apparatus according to claim 4,
wherein, in a case in which a target object corresponding to an object based on the first object data exists in the first space or it is assumed that the target object exists in the first space, the attribute data is data related to the target object.

6. The data acquisition apparatus according to claim 5,
wherein the attribute data is data related to a type of the target object.

7. The data acquisition apparatus according to claim 4,
wherein the attribute data is data related to a physical quantity of an object based on the first object data.

8. The data acquisition apparatus according to claim 4,
wherein the attribute data is data related to acquisition information or an acquisition condition of the first object data.

9. The data acquisition apparatus according to claim 1,
wherein a size of an object in the first space is associated with the first object data as the physical quantity, and
a size of an object in the second space is associated with the second object data as the physical quantity.

10. The data acquisition apparatus according to claim 9,
wherein, in the first conversion, the size of the object associated with the first object data is converted into the size of the object associated with the second object data in accordance with the reference that defines a relationship between sizes before and after conversion.

11. The data acquisition apparatus according to claim 10,
wherein the reference defines the relationship in which the size after the conversion is larger as the size before the conversion is larger and a ratio of the size after the conversion to the size before the conversion is smaller as the size before the conversion is larger.

12. The data acquisition apparatus according to claim 1,
wherein the processor is configured to further execute storage processing of storing reverse conversion data for reverse-converting the second object data into the first object data in association with the second object data.

13. The data acquisition apparatus according to claim 1,
wherein the processor is configured to further execute third acquisition processing of performing second conversion related to the physical quantity on the second object data, to acquire third object data associated with the physical quantity after the second conversion and corresponding to a space different from the second space.

14. The data acquisition apparatus according to claim 13,
wherein the third object data corresponds to a real space and is associated with a physical quantity of an object based on the third object data in the real space.

15. The data acquisition apparatus according to claim 14,
wherein the third object data is data for displaying an image of the object in a superimposed manner on an image of the real space.

16. A virtual space display system comprising:
the data acquisition apparatus according to claim 1; and
an image display apparatus that displays an image of the second space in which an object based on the second object data acquired by the data acquisition apparatus is disposed.

17. A data acquisition method comprising:
a step of acquiring, via a processor, first object data associated with a physical quantity that is converted into data and corresponding to a first space; and
a step of performing, via the processor, first conversion related to the physical quantity on the first object data based on a reference, to acquire second object data associated with the physical quantity after the first conversion and corresponding to a second space different from the first space.

18. A computer-readable non-transitory recording medium on which a program causing a computer to execute each step included in the data acquisition method according to claim 17 is recorded.

19. The data acquisition apparatus according to claim 2,
wherein the processor is configured to, in the first acquisition processing, acquire the physical quantity associated with the first object data based on a measurement result of a physical quantity related to a target object existing in the first space or an input operation of a user related to the physical quantity.

20. The data acquisition apparatus according to claim 2,
wherein attribute data related to the first object data is associated with the first object data, and
the processor is configured to, in the second acquisition processing, perform the first conversion on the first object data based on the reference corresponding to the attribute data.
